(19) United States
(12) Patent Application Publication
(10) Pub. No.: US 2026/0233089 A1
(43) Pub. Date: Aug. 13, 2026

(54) INFORMATION PROCESSING APPARATUS, INFORMATION PROCESSING METHOD, AND NON-TRANSITORY STORAGE MEDIUM

(71) Applicant: SONY GROUP CORPORATION, TOKYO (JP)

(72) Inventor: HISAKO SUGANO, TOKYO (JP)

(21) Appl. No.: 19/158,892

(22) PCT Filed: Feb. 1, 2024
(86) PCT No.: PCT/JP2024/003219

§ 371 Date: Aug. 22, 2025

(30) Foreign Application Priority Data
Mar. 16, 2023 (JP) 2023-041781

(51) Int. Cl. A63F 13/219; A63F 13/44; A63F 13/80; G06F 3/03

(52) U.S. Cl. CPC A63F 13/219; A63F 13/44; A63F 13/80; G06F 3/0308

(57) ABSTRACT

An information processing apparatus includes: a detection unit that detects a light emitter that emits light of a predetermined color from an image including a user carrying the light emitter; and a display control unit that causes a display unit to display first display information displayed at a predetermined position in the image in a superimposed manner on the image, wherein the display control unit, in a case where a relationship between a position of the light emitter detected by the detection unit and the predetermined position satisfies a predetermined condition, causes the display unit to display effect information that is information indicating a predetermined visual effect in a superimposed manner on the image.

### FIELD

The present invention relates to an information processing apparatus, an information processing method, and a non-transitory storage medium.

### BACKGROUND

Conventionally, a technique for tracking the path of a light emitter such as a penlight possessed by a user from an image is known. For example, a technique is known in which the start of the gesture of the user is recognized by the penlight turned on, the end of the gesture of the user is recognized by the penlight turned off, and the type of the gesture of the user is recognized from the movement state of the penlight from the start to the end of the gesture.

### CITATION LIST

### Patent Literature

Patent Literature 1: JP H09-311759 A

### SUMMARY

### Technical Problem

However, in the above-described conventional technique, only the type of the gesture of the user is recognized, and thus it is not always possible to support the improvement in movement performed by the user using the light emitter.

Therefore, the present disclosure proposes an information processing apparatus, an information processing method, and a non-transitory storage medium capable of supporting improvement in movement performed by the user using the light emitter.

### Solution to Problem

To solve the above problem, an information processing apparatus includes: a detection unit that detects a light emitter that emits light of a predetermined color from an image including a user carrying the light emitter; and a display control unit that causes a display unit to display first display information displayed at a predetermined position in the image in a superimposed manner on the image, wherein the display control unit, in a case where a relationship between a position of the light emitter detected by the detection unit and the predetermined position satisfies a predetermined condition, causes the display unit to display effect information that is information indicating a predetermined visual effect in a superimposed manner on the image.

### BRIEF DESCRIPTION OF DRAWINGS

FIG. 1 is a diagram for describing an outline of information processing according to the present disclosure.

FIG. 2 is a diagram illustrating a configuration example of an information processing apparatus according to an embodiment.

FIG. 3 is a flowchart illustrating a flow of processing of initial setting according to the embodiment.

FIG. 4 is a flowchart illustrating a flow of processing of penlight color calibration according to the embodiment.

FIG. 5 is a flowchart illustrating a flow of processing of subject standing position/movable range calibration according to the embodiment.

FIG. 6 is a diagram illustrating an example of a silhouette according to the embodiment.

FIG. 7 is a flowchart illustrating a flow of processing during a game according to the embodiment.

FIG. 8 is a flowchart illustrating a flow of processing of penlight position detection/timing analysis according to the embodiment.

FIG. 9 is a diagram for describing an outline of display processing of effect information according to a modification.

FIG. 10 is a hardware configuration diagram illustrating an example of a computer that achieves a function of the information processing apparatus according to the present disclosure.

### DESCRIPTION OF EMBODIMENTS

The embodiment of the present disclosure will be described below in detail on the basis of the drawings. Note that, in each embodiment described below, the same parts are designated by the same reference numerals, and duplicate description will be omitted.

### 1. Embodiment

### 1-1. Introduction

In recent years, in an event venue (hereinafter, may be referred to as the “event venue”) such as a music live concert, the number of users using a light emitter that emits light of a predetermined color such as a penlight or a glow stick has increased. Hereinafter, a case where the light emitter is a penlight will be described, but the light emitter according to the present embodiment may be, for example, another light emitter other than the penlight such as a glow stick. For example, in the case of a music live concert, it is possible to boost the production of the event venue by turning on/off the penlights possessed by the users in the event venue all at once or changing the colors of the penlights in accordance with production or sound of music. In addition, various penlights are manufactured/sold for such users.

Here, the penlight refers to a flashlight that is small and excellent in portability. As the shape of the penlight, a shape like an elongated pen having a tubular structure (also referred to as a pen type or a stick type; hereinafter, may be referred to as a “pen type”) is well known, but there are penlights of various shapes such as a fan type penlight and a wristwatch type penlight. Hereinafter, a case where the penlight is of a pen type will be described, but the penlight according to the present embodiment may have another shape other than the pen type, such as a fan type penlight or a wristwatch type penlight.

In addition, the penlight includes a light emitting element, a power supply, a power supply switch, and the like. For example, the light emitting element is a light bulb, an LED, a fluorescent lamp, or the like. In addition, as the type of color emitted by the light emitting element of the penlight (also referred to as the number of color development of the penlight), there are one that can light only a single color and one that can light a plurality of colors such as white, red, blue, yellow, green, purple, and orange by switching. In addition, among the penlights that can be turned on by switching a plurality of colors, there are one whose color is manually switched by a user and one whose color is automatically switched by a control apparatus that controls the penlight.

In addition, as a penlight for a live concert, a wireless control type penlight is manufactured/sold. The wireless control type penlight has a wireless communication function assuming relatively close range communication, for example, a near field communication (NFC), Bluetooth (registered trademark), or an infrared system, and is connected by wireless communication to a control apparatus that controls the penlight. For example, a user who is an audience of a live concert purchases a penlight incorporating an NFC tag in advance. In addition, in a live concert venue, an NFC tag is installed in each seat. In addition, when arriving at a seat in a live concert venue, a user who is an audience of the live concert holds a penlight purchased in advance over the seat to pair the penlight and the seat. In addition, the control apparatus used by the operator of the live concert transmits a control signal for controlling the timing of turning on the penlight and the color to the address of each penlight, thereby controlling the timing of turning on the penlight possessed by each user and the color. In this case, since the address of the penlight corresponding to each seat is known, a figure or a character (for example, characters indicating the name of a singer, and the like) can be displayed in the live concert venue by causing one penlight to function as one pixel.

As described above, conventionally, penlights boost the production of an event venue, but have often become ornaments or mementos after the users returns home. For example, conventionally, since a control apparatus exists only in a live concert venue, in a case where a user uses a penlight at home, the user has to, for example, press a button for switching the color by himself/herself to change the color of the penlight. In addition, conventionally, it has not been possible to say that there is a sufficient opportunity for users to utilize the penlights in a place other than an event venue. That is, conventionally, opportunities for users to enjoy using the penlights at home have been limited.

On the other hand, an information processing apparatus according to the present disclosure provides an application (hereinafter, may be referred to as “game app A1”) that enables to experience a game in which the user performs a movement corresponding to choreography using a penlight anytime and anywhere using an information processing apparatus such as a penlight and a smartphone owned by the user. Note that a state in which the user performs a movement corresponding to the choreography using the penlight may appear to be dancing. Therefore, in the following, performing a movement corresponding to the choreography using the penlight by the user may be described as the user dancing the choreography using the penlight.

Specifically, the information processing apparatus provides the game app A1 that causes a speaker such as of a smartphone owned by the user to output a voice corresponding to music selected by the user from a plurality of pieces of music, such as karaoke. In addition, the information processing apparatus provides the game app A1 that displays guidance information corresponding to choreography according to music on the screen of a smartphone or the like owned by the user during reproduction of the music selected by the user. For example, the information processing apparatus displays, on the screen, as the guidance information, target information (hereinafter, may be referred to as “first display information”) indicating where in the image the penlight is to be located. In addition, the information processing apparatus displays, on the screen, as the guidance information, timing information (hereinafter, may be referred to as “second display information”) indicating at which timing the penlight is to be positioned by the user at the location indicated by the target information. In addition, in a case where the penlight is located at the location indicated by the target information at the timing indicated by the timing information, the information processing apparatus displays, on the screen, effect information (hereinafter, may be referred to as “effect information”), which is information indicating a predetermined visual effect. For example, the information processing apparatus may display effect information that is visual information that causes the user to recognize that the user is good at choreography (alternatively, causes the user to feel complimented). In addition, the information processing apparatus provides the game app A1 that enables a user to selfie a state of dancing choreography while viewing the screen using a front-facing camera such as of a smartphone owned by the user.

As a result, the information processing apparatus can enable the user to dance the choreography according to the music anytime and anywhere (for example, even at home). That is, the information processing apparatus can provide an opportunity for the user to enjoy using a penlight at a place other than the event venue (for example, home). In addition, the information processing apparatus can support the user to improve the movement (for example, the movement of choreography according to music) performed by using the penlight. In addition, the information processing apparatus can post a moving image captured by the user on a social networking service (SNS) or the like. In addition, the information processing apparatus can encourage the user to practice the movement (for example, the movement of choreography according to music) performed using the penlight with the motivation that the user's own moving image is browsed or evaluated by other users. In addition, the information processing apparatus can encourage the user to spontaneously practice so that the user becomes good at penlight choreography before an event such as a music live concert. As a result, the information processing apparatus can enhance the sense of unity of the users in the event venue. In addition, the information processing apparatus can improve the appearance of choreography as production in the event venue and can generate a sense of unity in the event venue by unifying choreography that is originally and separately performed for each user. In addition, the information processing apparatus can improve the enjoyment of participation of the user in the event.

### 1-2. Outline of Information Processing

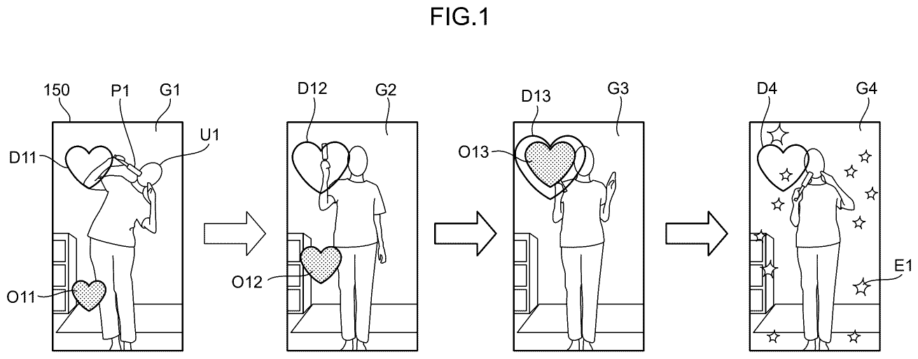

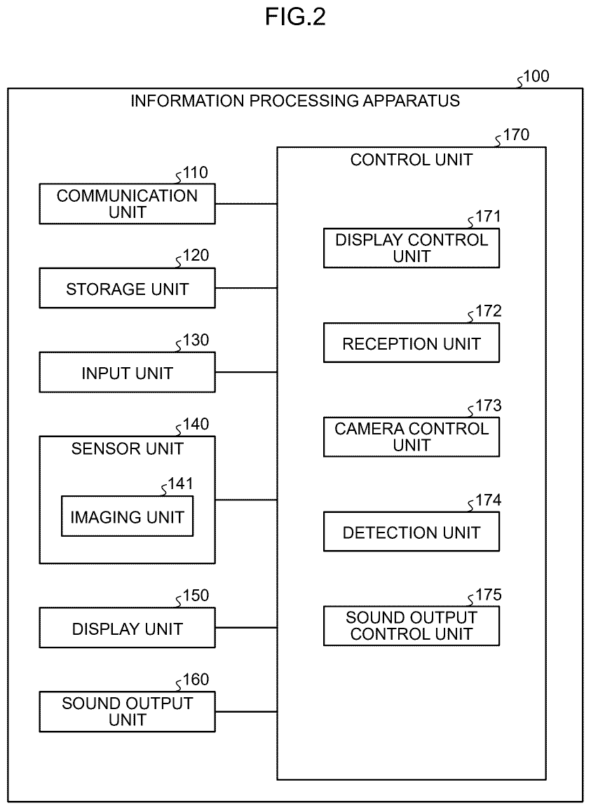

FIG. 1 is a diagram for describing an outline of information processing according to the present disclosure. Information processing according to the present disclosure is executed by an information processing apparatus 100 (see FIG. 2). The information processing apparatus 100 is an information processing apparatus that provides a service of the game app A1 described above. In FIG. 1, a case where the information processing apparatus 100 is a smartphone used by a user will be described. Note that the information processing apparatus 100 is not limited to a smartphone, but may be, for example, a smart device such as a tablet terminal, a feature phone, a personal computer (PC), a personal digital assistant (PDA), and a game machine or AV device having a communication function.

Prior to describing FIG. 1, preliminary preparation performed by a user U1 will be described. First, in a case where a penlight P1 possessed by the user U1 is a wireless control type penlight, the user U1 wirelessly connects the penlight P1 and the information processing apparatus 100. For example, the penlight P1 has a wireless communication function such as NFC, Bluetooth (registered trademark), or an infrared system. In addition, the information processing apparatus 100 has a wireless communication function such as NFC, Bluetooth (registered trademark), or an infrared system. The penlight P1 and the information processing apparatus 100 are wirelessly connected by performing mutual authentication between the penlight P1 and the information processing apparatus 100. Subsequently, in a case where the penlight P1 and the information processing apparatus 100 are wirelessly connected, the game app A1 is opened on the information processing apparatus 100.

Note that, in a case where the penlight P1 is not a wireless control type penlight (penlight that does not have a wireless communication function), the user U1 does not need to wirelessly connect the penlight P1 and the information processing apparatus 100. In a case where the penlight P1 is not a wireless control type penlight, the user U1 performs some operation to open the game app A1 on the information processing apparatus 100. For example, the user U1 performs an operation of selecting an icon corresponding to the game app A1 displayed on the screen of the information processing apparatus 100.

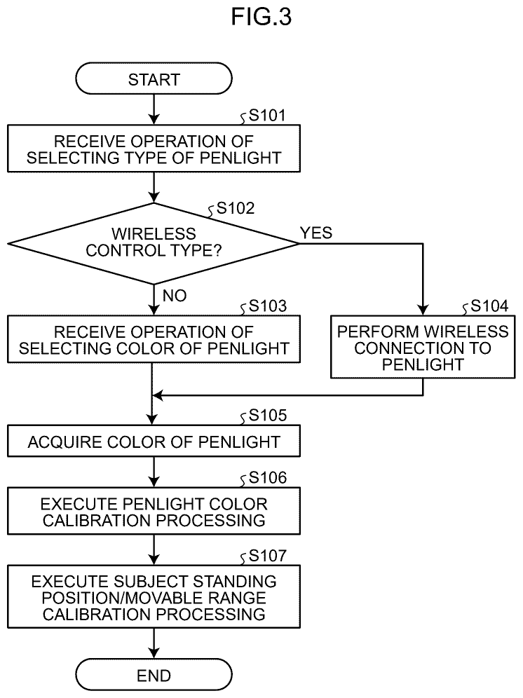

Next, the user U1 installs the information processing apparatus 100 at a position where the entire body of the user U1 can be captured. For example, the information processing apparatus 100 includes a camera. For example, the information processing apparatus 100 includes a front-facing camera. For example, the user U1 installs the information processing apparatus 100 at a position where the entire body of the user U1 can be captured by the front-facing camera included in the information processing apparatus 100. In addition, the information processing apparatus 100 includes a screen. For example, the user U1 stands at a position facing the screen included in the information processing apparatus 100. Next, the user U1 performs initial setting for capturing the motion of choreography by the penlight P1 and the user U1 by the camera included in the information processing apparatus 100. Note that the initial setting will be described in detail with reference to FIGS. 3 to 6 to be described below, and thus the description thereof will be omitted here.

The user U1 experiences a game of the game app A1 after performing the above-described preliminary preparation. For example, the user U1 selects one piece of music from a plurality of pieces of music selectable on the game app A1, and experiences a game corresponding to the selected music. For example, the information processing apparatus 100 includes a speaker. When the game starts, the information processing apparatus 100 causes the speaker to output a voice including a performance and a singing voice of a singer corresponding to the music. In addition, the information processing apparatus 100 displays the above-described target information, the timing information, and, in a case where predetermined conditions are satisfied, the effect information on the screen.

FIG. 1 will now be described. FIG. 1 illustrates frames included in a moving image obtained by capturing a scene in which the user U1 carrying the penlight P1 experiences the game of the game app A1 in a room, and the frames are arranged in chronological order. In FIG. 1, each image is displayed on the screen (corresponding to a display unit 150 illustrated in FIG. 2) included in the information processing apparatus 100. Here, the user U1 experiencing the game of the game app A1corresponds to that the user performs a movement corresponding to the choreography using the penlight corresponding to the music during the reproduction of the music (in other words, the user dances the choreography using the penlight).

In the diagram at the left end of FIG. 1, as an example of the target information, the information processing apparatus 100 displays a figure D11 indicating a heart-shaped outline in a superimposed manner on the upper left position of an image G1 on the screen. The user U1 waves the penlight P1 so that the penlight P1 enters a region (for example, a region surrounded by a line of the figure D11) indicated by the target information. In addition, the information processing apparatus 100 expands or contracts the figure D11 so as to pulse in accordance with the beats of the music (also referred to as beats).

In this manner, the information processing apparatus 100 may display, for example, a linear figure indicating an outline of the shape of the figure as the target information in a superimposed manner on the image. As a result, when the user U1 aligns the position of the penlight P1 with the display position of the target information, the information processing apparatus 100 can prevent the penlight P1 from being hidden behind the target information in the image and becoming invisible. Note that the information processing apparatus 100 may display a figure without an outline, such as a transparent figure, as the target information in a superimposed manner on the image.

In addition, in FIG. 1, the information processing apparatus 100 displays target information of the same color as the color of the light emitted by the penlight P1 (hereinafter, may be referred to as the color of the penlight P1) in a superimposed manner on the image G1. For example, in a case where the color of the penlight P1 is green, the information processing apparatus 100 displays the figure D11 by a green line same as the color of the penlight P1 in a superimposed manner on the image G1. In this manner, the information processing apparatus 100 may change the color of the target information according to the color of the light emitted by the penlight P1.

In addition, the information processing apparatus 100 controls the timing at which the timing information is sent into the image according to at least one of the beat, time, rhythm, or tempo of the music. In FIG. 1, as an example of the timing information, the information processing apparatus 100 displays a figure O11 having a heart shape moving in the image from the outside of the image (below the image in FIG. 1) toward the display position of the target information in a superimposed manner on the image G1. As described above, the shape of the timing information is the same as or similar to the shape of the target information. As a result, the information processing apparatus 100 can cause the user U1 to expect that the timing information is superimposed on the position of the target information.

In addition, in FIG. 1, the information processing apparatus 100 displays timing information of the same color as an image color (also referred to as a member color) of a member who sings its part according to the song part of the music. For example, in a case where the image color of the member singing the part illustrated in FIG. 1 is yellow, the information processing apparatus 100 displays the figure O11 filled with yellow that is the same as the color of the member color in a superimposed manner on the image G1. In addition, the information processing apparatus 100 expands or contracts the figure O11 so as to pulse in accordance with the beats of the music (also referred to as beats).

In the diagram second from the left end of FIG. 1, as an example of the target information, the information processing apparatus 100 displays a figure D12 indicating a heart-shaped outline in a superimposed manner on the upper left position of an image G2 on the screen. The diagram second from the left end of FIG. 1 is different from the diagram at the left end of FIG. 1 in that the figure D12 is displayed larger than the figure D11 as a result of expansion and contraction of the target information according to the beat of the music. In addition, as an example of the timing information, the information processing apparatus 100 displays a figure O12 having a heart shape moving in the image from below the image toward the position of the figure D12 in a superimposed manner on the image G2 on the screen. The diagram second from the left end of FIG. 1 is different from the diagram at the left end of FIG. 1 in that the figure O12 is displayed larger than the figure O11 as a result of expansion and contraction of the timing information according to the beat of the music. In addition, the diagram second from the left end of FIG. 1 is different from the diagram at the left end of FIG. 1 in that the figure O12 is displayed at a higher position in the image than the figure O11 by the amount of movement of the timing information toward the display position of the target information.

In the diagram third from the left end of FIG. 1, as an example of the target information, the information processing apparatus 100 displays a figure D13 indicating a heart-shaped outline in a superimposed manner on the upper left position of an image G3 on the screen. The diagram third from the left end of FIG. 1 is different from the diagram second from the left end of FIG. 1 in that the figure D13 is displayed larger than the figure D12 as a result of expansion and contraction of the target information according to the beat of the music. In addition, as an example of the timing information, the information processing apparatus 100 displays a figure O13 having a heart shape that has reached the position of the figure D13 in a superimposed manner on the image G3 on the screen. The diagram third from the left end of FIG. 1 is different from the diagram second from the left end of FIG. 1 in that the figure O13 is displayed larger than the figure O12 as a result of expansion and contraction of the timing information according to the beat of the music. In addition, the diagram third from the left end of FIG. 1 is different from the diagram second from the left end of FIG. 1 in that the figure O13 is displayed at a higher position in the image than the figure O12 by the amount of movement of the timing information toward the display position of the target information.

As illustrated in the diagram third from the left end of FIG. 1, in a case where it is determined that the position of the penlight P1 and the display position of the target information overlap at the timing when the distance between the display position (for example, the center position of the figure D13) of the target information and the display position (for example, the center position of the figure O13) of the timing information falls within a predetermined range, the information processing apparatus 100 displays the effect information in a superimposed manner on the image G3 on the screen. For example, in a case where the position of the penlight P1 is located inside the region (for example, a region surrounded by the line of the figure D13) indicated by the target information, the information processing apparatus 100 displays the effect information in a superimposed manner on the image G3. Note that the diagram third from the left end of FIG. 1 is a diagram illustrating the timing at which the position of the penlight P1 and the display position of the target information just overlap, and thus the effect information is not yet displayed.

The diagram fourth from the left end of FIG. 1 corresponds to an image G4 corresponding to the frame next to the image G3 third from the left end of FIG. 1. In the diagram fourth from the left end of FIG. 1, the information processing apparatus 100 displays effect information E1 indicating a glittering stage effect in a superimposed manner on the image G4. In addition, as an example of the target information, the information processing apparatus 100 displays a figure D14 indicating a heart-shaped outline in a superimposed manner on the upper left position of the image G4 on the screen. The diagram fourth from the left end of FIG. 1 is different from the diagram third from the left end of FIG. 1 in that the figure D14 is displayed smaller than the figure D13 as a result of expansion and contraction of the target information according to the beat of the music. In addition, the diagram fourth from the left end of FIG. 1 is different from the diagram third from the left end of FIG. 1 in that the timing information is not displayed because the timing information has already been sent out of the image.

### 1-3. Configuration of Information Processing Apparatus

FIG. 2 is a diagram illustrating a configuration example of the information processing apparatus 100 according to the embodiment. As illustrated in FIG. 2, the information processing apparatus 100 includes a communication unit 110, a storage unit 120, an input unit 130, a sensor unit 140, the display unit 150, a sound output unit 160, and a control unit 170.

The communication unit 110 is achieved by, for example, a network interface card (NIC) or the like. Then, the communication unit 110 may be connected to a network in a wired or wireless manner, and transmit and receive information to and from, for example, a wireless control type penlight or another information processing apparatus 100.

The storage unit 120 is achieved by, for example, a semiconductor memory element such as random access memory (RAM) or flash memory, or a storage apparatus such as a hard disk or an optical disk. For example, the storage unit 120 stores information regarding various programs. In addition, the storage unit 120 stores information regarding music. For example, the storage unit 120 stores information regarding a song part of music. For example, the storage unit 120 stores information in which the song part of music is associated with the image color of a member who sings its part. In addition, the storage unit 120 stores information regarding the color of the penlight. For example, the storage unit 120 stores information regarding a pixel value library for each color of the penlight.

The input unit 130 is an input device that receives various operations from the user. For example, the input unit 130 includes a button or the like for inputting characters, numbers, and the like. In addition, in a case where the display unit 150 is a touch panel type display, a part of the display unit 150 functions as the input unit 130.

The sensor unit 140 includes various sensors. For example, the sensor unit 140 includes a distance measuring sensor that detects a distance to an object. For example, the sensor unit 140 includes a time of flight (ToF) camera or an infrared camera. In addition, the sensor unit 140 includes a gyro sensor.

In addition, the sensor unit 140 includes an imaging unit 141. The imaging unit 141 is an image sensor (camera) that captures an image of a subject. For example, the imaging unit 141 is achieved by a complementary metal oxide semiconductor (CMOS) image sensor, a charge-coupled device (CCD) image sensor, or the like. For example, the imaging unit 141 may include a front-facing camera. In addition, the imaging unit 141 may include a stereo camera. In addition, the imaging unit 141 may include a monocular camera instead of the stereo camera. In addition, in the following description, the imaging unit 141 may be referred to as the camera.

The display unit 150 is a display device that displays various types of information. For example, the display unit 150 is a display screen achieved by a liquid crystal display (LCD), an organic electro-luminescent display (organic EL display), or the like. The display unit 150 displays various types of information under the control of the control unit 170. In addition, in the following description, the display unit 150 may be referred to as the screen.

The sound output unit 160 outputs a sound such as a voice. For example, the sound output unit 160 is achieved by a speaker. For example, the sound output unit 160 outputs a voice of the music. In addition, in the following description, the sound output unit 160 may be referred to as the speaker.

The control unit 170 is a controller, and is achieved by, for example, a central processing unit (CPU), a micro processing unit (MPU), an application specific integrated circuit (ASIC), a field programmable gate array (FPGA), or the like executing various programs stored in a storage apparatus inside the information processing apparatus 100 using a storage area such as RAM as a work area. In the example illustrated in FIG. 2, the control unit 170 includes a display control unit 171, a reception unit 172, a camera control unit 173, a detection unit 174, and a sound output control unit 175.

The display control unit 171 causes the display unit 150 to display various types of information. For example, the display control unit 171 causes the display unit 150 to display information regarding the game app A1.

The reception unit 172 receives various types of information. For example, the reception unit 172 receives various operations from the user via the input unit 130.

The camera control unit 173 controls the imaging unit 141 (hereinafter, may be referred to as the camera). For example, the camera control unit 173 controls the camera to adjust setting values of camera parameters such as exposure, ISO sensitivity, or shutter speed.

The detection unit 174 detects various types of information. For example, the detection unit 174 detects a penlight from an image including a user carrying the penlight that emits light of a predetermined color.

The sound output control unit 175 controls the sound output unit 160 (hereinafter, may be referred to as the speaker). For example, the sound output control unit 175 causes the sound output unit 160 to output a voice of the music.

### 1-4. Procedure of Information Processing

Here, a procedure of information processing according to the embodiment will be described with reference to FIGS. 3 to 8.

First, a procedure of processing of initial setting according to the embodiment will be described with reference to FIGS. 3 to 6. FIG. 3 is a flowchart illustrating a flow of processing of initial setting according to the embodiment. The processing of initial setting is started when the game app A1 is opened. In FIG. 3, the display control unit 171 causes the display unit 150 to display information regarding the initial setting. For example, the display control unit 171 causes the display unit 150 to display a screen for allowing the user to select the type of penlight as the information regarding the initial setting. For example, the display control unit 171 causes the display unit 150 to display an option indicating whether or not the type of penlight is the wireless control type.

The reception unit 172 receives a selection operation of selecting the type of penlight from the user via the input unit 130 (Step S101). For example, the reception unit 172 receives a selection operation of selecting one option of the options displayed on the screen. Subsequently, when receiving the selection operation from the user, the reception unit 172 determines whether or not the type of penlight selected by the user is the wireless control type (Step S102).

When determining that the type of penlight selected by the user is not the wireless control type (Step S102; No), the reception unit 172 receives a selection operation of selecting the color of the penlight from the user (Step S103). For example, when the reception unit 172 determines that the type of penlight selected by the user is not the wireless control type, the display control unit 171 causes the display unit 150 to display options corresponding to respective colors. The user selects the color of the penlight from the options displayed on the display unit 150. When receiving the selection operation from the user, the reception unit 172 acquires information regarding the color of the penlight selected by the user (Step S105). When acquiring the information regarding the color of the penlight, the reception unit 172 stores the information regarding the color of the penlight in the storage unit 120.

In addition, when determining that the type of penlight selected by the user is the wireless control type (Step S102; Yes), the reception unit 172 wirelessly connects to the penlight via the communication unit 110 (Step S104). When wirelessly connected to the penlight, the reception unit 172 refers to the storage unit 120 to acquire the information regarding the color of the penlight corresponding to the model of the connected penlight (Step S105).

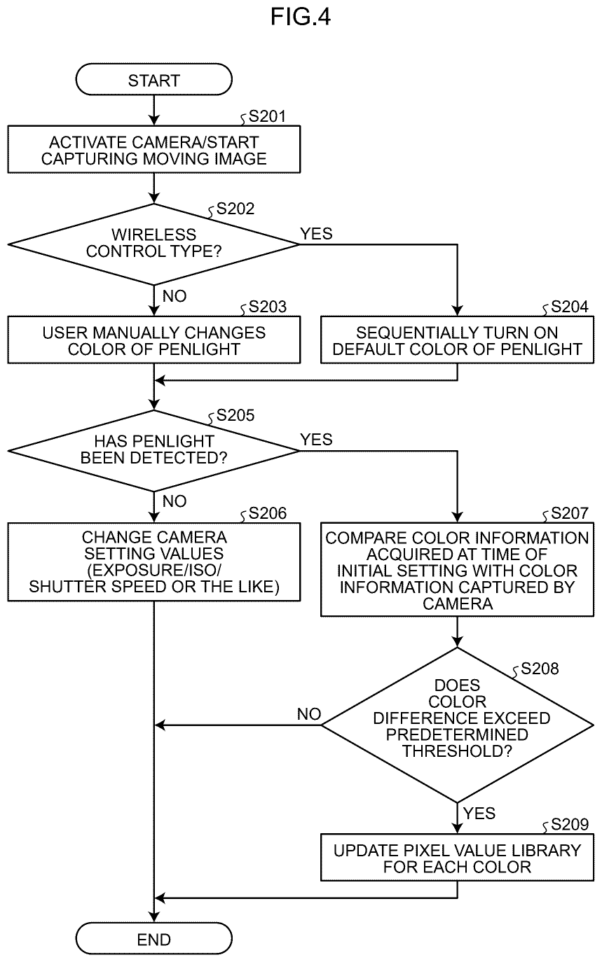

Subsequently, in a case where the information regarding the color of the penlight is acquired by the reception unit 172, the information processing apparatus 100 executes processing of penlight color calibration (Step S106). Here, the processing of penlight color calibration is required for the reasons described below. (1) Because the color gamut of the light emitting element captured in the image varies depending on the penlight owned by the user. (2) Since the capturing environment and the capturing device of the user are unknown, the detection accuracy of the color of the penlight changes depending on the brightness and the standing position of the user. For example, even in a case where the color of penlight is known, the hue in the image changes depending on the capturing camera or the capturing environment. In addition, by capturing the penlight in advance and matching the color of the penlight caught by the camera with the known color of the penlight, the detection accuracy when detecting the penlight from the image is improved. (3) Because the resolution, frame rate, exposure setting, and the like of the camera differ depending on the type of the capturing device owned by the user. Note that the processing of penlight color calibration will be described in detail with reference to FIG. 4 described below, and thus the description thereof will be omitted here.

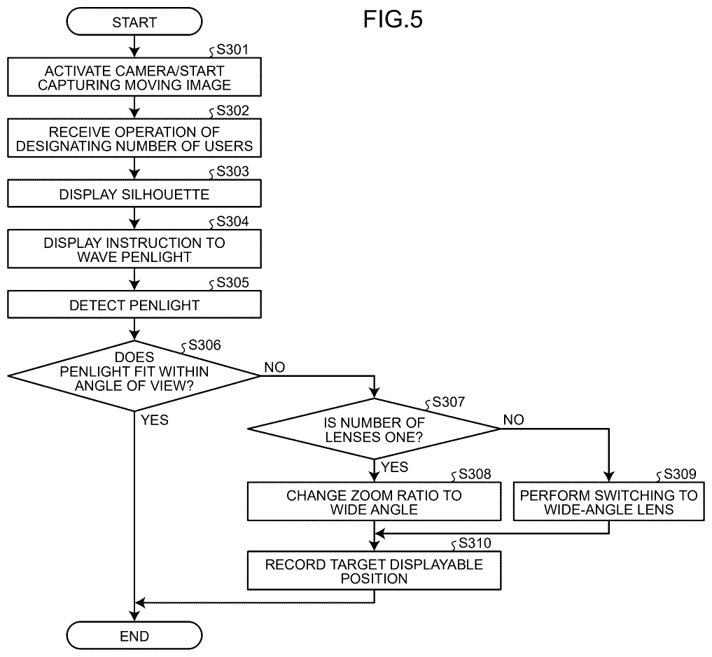

Subsequently, in a case where the processing of penlight color calibration by the information processing apparatus 100 is ended, the information processing apparatus 100 executes the processing of subject standing position/movable range calibration (Step S107). Here, the processing of subject standing position/movable range calibration is required for the reasons described below. (1) The movable range of the penlight varies depending on the user. (2) Because it is necessary to adjust the display position of the target information according to the height of the subject because the distance between the camera arranged by the user and the subject is unknown. For example, since the length of the arm is different between an adult and a child, it may be better to change the position of the target information depending on the angle of view. (3) Because when the number of users is plural, it is necessary to adjust the display position of the target information according to the standing position of each user. Note that the processing of subject standing position/movable range calibration will be described in detail with reference to FIG. 5 described below, and thus the description thereof will be omitted here. After executing the processing of subject standing position/movable range calibration, the reception unit 172 ends the processing of initial setting.

FIG. 4 is a flowchart illustrating a flow of processing of penlight color calibration according to the embodiment. The processing of penlight color calibration is started when the reception unit 172 acquires information regarding the color of the penlight. In FIG. 4, the camera control unit 173 activates the camera and starts capturing a moving image (Step S201).

The reception unit 172 determines whether the type of the penlight possessed by the user is the wireless control type (Step S202). For example, the reception unit 172 may determine whether or not the type of the penlight is the wireless control type, similarly to Step S102 described with reference to FIG. 3.

When the reception unit 172 determines that the type of the penlight is not the wireless control type (Step S202; No), the display control unit 171 causes the display unit 150 to display information instructing the user to manually turn on the penlight by pressing an analog switch or the like. For example, the display control unit 171 causes information for sequentially instructing a color to be turned on to be displayed on the basis of the information regarding the color of the penlight received by the reception unit 172. The user manually turns on the penlight to change the color of the penlight (Step S203).

In addition, when the reception unit 172 determines that the type of the penlight is the wireless control type (Step S202; Yes), the control unit 170 sequentially turns on the default color of the penlight (Step S204).

The detection unit 174 acquires the moving image captured by the camera from the camera. Subsequently, the detection unit 174 determines whether a penlight has been detected from each frame included in the acquired moving image (Step S205). For example, the detection unit 174 determines whether or not a pixel having a luminance value exceeding a predetermined threshold is present among the pixels included in each frame.

When determining that there is no pixel having a luminance value exceeding the predetermined threshold, the detection unit 174 determines that a penlight has not been detected. When the detection unit 174 determines that the penlight has not been detected (Step S205; No), the camera control unit 173 controls the camera to change the setting values of the camera parameters such as the exposure, the ISO sensitivity, or the shutter speed (Step S206). The detection unit 174 acquires, from the camera, the moving image captured by the camera in which the setting values of the camera parameters have been changed.

In addition, when determining that there is a pixel having a luminance value exceeding the predetermined threshold, the detection unit 174 determines that a penlight has been detected. For example, the detection unit 174 specifies a region corresponding to the pixel having the luminance value exceeding the predetermined threshold in the image as a lighting region of the penlight (hereinafter, may be referred to as a penlight region). When determining that the penlight has been detected (Step S205; Yes), the detection unit 174 compares the information regarding the color of the penlight acquired at the time of initial setting (specifically, in Step S105 described with reference to FIG. 3) with the information regarding the color of the penlight actually captured by the camera (Step S207). For example, even in a case where the color of the penlight is green, it is known that the RGB value of each pixel in the penlight region in the image has a range such that the value of R is 0 to 0.3, the value of G is 0.6 to 1.0, and the value of B is 0.3 to 0.4. Therefore, the detection unit 174 stores the information regarding the color of the penlight acquired at the time of initial setting and the information regarding the color of the penlight actually captured by the camera (for example, the range of each value of RGB of each pixel in the penlight region in the image) in the storage unit 120 in association with each other. Hereinafter, information in which the information regarding the color of the penlight acquired at the time of initial setting is associated with the information regarding the color of the penlight actually captured by the camera (for example, the range of each value of RGB of each pixel in the penlight region in the image) may be referred to as a pixel value library for each color.

The detection unit 174 determines whether or not a color difference, which is a difference between the information regarding the color of the penlight acquired at the time of initial setting and the information regarding the color of the penlight actually captured by the camera, exceeds a predetermined threshold (Step S208). When the detection unit 174 determines that the color difference does not exceed the predetermined threshold (Step S208; No), the processing ends. In addition, when the detection unit 174 determines that the color difference exceeds the predetermined threshold (Step S208; Yes), the pixel value library for each color stored in the storage unit 120 is updated (Step S209). After updating the pixel value library for each color, the detection unit 174 ends the processing.

As described with reference to FIG. 4, the information processing apparatus 100 executes the processing of penlight color calibration. As a result, the information processing apparatus 100 can improve the detection accuracy when detecting the penlight from each frame of the moving image. In addition, since the information processing apparatus 100 can improve the detection accuracy when detecting the penlight, it is possible to improve the detection accuracy when detecting the movement using the penlight by the user from each frame of the moving image. In addition, the information processing apparatus 100 can display effective effect information corresponding to the color of the penlight by acquiring the information regarding the color of the penlight in advance. Accordingly, the information processing apparatus 100 can achieve the game app A1 corresponding not only to the wireless control type penlight but also to the penlight that is not of the wireless control type.

FIG. 5 is a flowchart illustrating a flow of processing of subject standing position/movable range calibration according to the embodiment. The processing of subject standing position/movable range calibration is started when the processing of penlight color calibration by the information processing apparatus 100 is ended. Note that it is assumed that the position of the camera is fixed during the processing of subject standing position/movable range calibration, and the positional relationship between the camera and the user who is the subject does not greatly change. In FIG. 5, the camera control unit 173 activates the camera and starts capturing a moving image (Step S301).

The reception unit 172 receives, from the user, a designation operation of designating the number of subjects (users) via the input unit 130 (Step S302). For example, the reception unit 172 receives, from the user, an operation of inputting a number indicating the number of subjects as the designation operation. Note that the reception unit 172 may automatically detect the number of subjects from the image by executing face recognition processing or posture estimation processing on the image. In this manner, the reception unit 172 acquires information regarding the number of subjects.

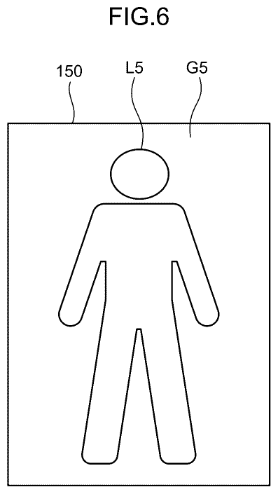

In a case where the information regarding the number of subjects is acquired by the reception unit 172, the display control unit 171 causes the display unit 150 to display silhouettes of the corresponding number of subjects (Step S303). FIG. 6 is a diagram illustrating an example of a silhouette according to the embodiment. In FIG. 6, the information processing apparatus 100 causes the display unit 150 to display a silhouette L5 of a doll in a superimposed manner on the image. The information processing apparatus 100 can designate an approximate standing position of the subject by displaying the silhouette of the doll together with guide information for the user such as stand to fit in this frame. The user stands at a position that fits the silhouette of the doll.

In addition, the display control unit 171 causes the display unit 150 to display instruction information for instructing the user to wave the penlight (Step S304). For example, the display control unit 171 causes the display unit 150 to display instruction information for instructing the user to wave the penlight so as to draw a circle. In addition, the display control unit 171 causes the display unit 150 to display instruction information for instructing the user to wave the penlight left and right, back and forth, and up and down.

The detection unit 174 acquires the moving image captured by the camera from the camera. Subsequently, the detection unit 174 detects a penlight from each frame included in the acquired moving image (Step S305). Subsequently, the detection unit 174 detects the path of the penlight waved so as to draw a circle from the image, and measures the movable range of the penlight on the basis of the detected path. In addition, the detection unit 174 detects the path of the penlight waved left and right, back and forth, and up and down from the image, and measures the movable range of the penlight on the basis of the detected path. When measuring the movable range of the penlight, the detection unit 174 stores information regarding the measured movable range of the penlight in the storage unit 120.

In addition, when detecting the penlight from the image, the detection unit 174 determines whether the penlight fits within the angle of view (Step S306). When the detection unit 174 determines that the penlight fits within the angle of view (Step S306; Yes), the processing ends. In addition, when the detection unit 174 determines that the penlight does not fit within the angle of view (Step S306; No), it is determined whether or not the number of camera lenses is one (Step S307). For example, the detection unit 174 refers to the storage unit 120 that stores information regarding the number of camera lenses, and determines whether the number of camera lenses is one.

When the detection unit 174 determines that the number of camera lenses is one (Step S307; Yes), the camera control unit 173 changes the zoom ratio of the camera to a wide angle (Step S308). In addition, when the detection unit 174 determines that the number of camera lenses is not one (that is, plural) (Step S307; No), the camera control unit 173 switches the camera lenses to wide-angle lenses (Step S309).

In addition, the detection unit 174 acquires the moving image captured by the camera changed to a wide-angle lens or the like from the camera. Subsequently, the detection unit 174 specifies a displayable position of the target information on the basis of each frame included in the acquired moving image. For example, the detection unit 174 may specify a position corresponding to the movable range of the penlight as the displayable position of the target information. When the displayable position of the target information is specified, the detection unit 174 records information regarding the displayable position of the target information in the storage unit 120 (Step S310).

As described with reference to FIG. 5, the information processing apparatus 100 executes the processing of subject standing position/movable range calibration. As a result, the information processing apparatus 100 can provide the user with a game experience that does not depend on the user's body shape such as the user's height and arm length. In addition, since the information processing apparatus 100 can display the target information at a position according to the user's height and arm length, the user can accurately tap the target information. In addition, the information processing apparatus 100 can improve the degree of freedom of the display position of the target information by specifying the displayable position of the target information. In addition, by receiving the designation of the number of people, the information processing apparatus 100 can achieve a game that can be played by a plurality of people at the same time. In addition, since the information processing apparatus 100 can predict the timing at which the penlight is positioned in the display region of the target information to some extent by measuring the movable range of the penlight, it is possible to accurately detect the timing at which the penlight is positioned in the display region of the target information. In addition, the information processing apparatus 100 can display the effect information at an appropriate place in the image by measuring the movable range of the penlight.

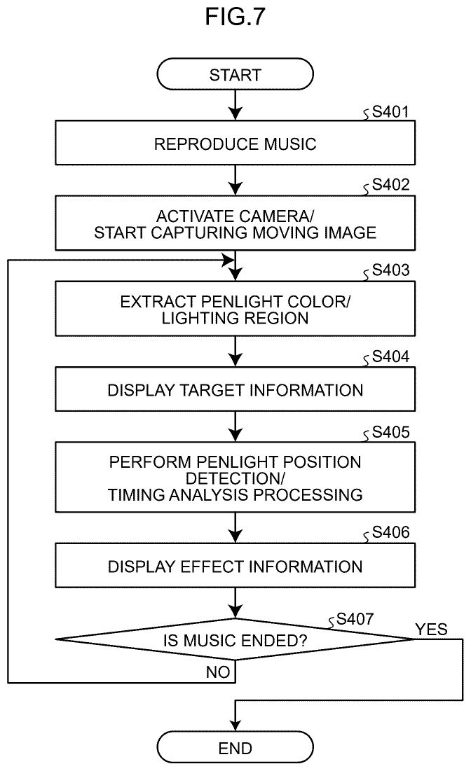

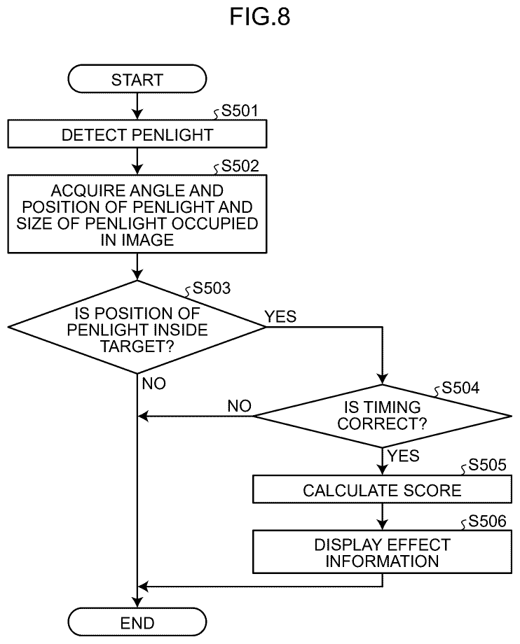

Next, a procedure of processing during a game according to the embodiment will be described with reference to FIGS. 7 to 8. FIG. 7 is a flowchart illustrating a flow of processing during a game according to the embodiment. The processing during a game is started in a case where the processing of initial setting by the information processing apparatus 100 ends. The game of the game app A1 starts with the reproduction of the music. In FIG. 7, the sound output control unit 175 causes the sound output unit 160 to output a voice of the music (Step S401). In addition, the camera control unit 173 activates the camera and starts capturing a moving image (Step S402).

In addition, the detection unit 174 acquires the moving image captured by the camera from the camera. Subsequently, the detection unit 174 extracts respective colors of the penlights and lighting regions corresponding to the respective colors of the penlights from each frame included in the acquired moving image (Step S403). For example, the detection unit 174 compares the pixel value library for each color stored in the storage unit 120 with the pixel value of each pixel of each frame, thereby extracting the respective colors of the penlights and lighting regions corresponding to the respective colors of the penlights from each frame.

In addition, the display control unit 171 causes the display unit 150 to display the target information displayed at a predetermined position in the image in a superimposed manner on the image on the basis of the information regarding the displayable position of the target information. For example, the display control unit 171 causes the display unit 150 to display the target information whose size changes according to the beat of the music in a superimposed manner on the image. In addition, the display control unit 171 causes the display unit 150 to display the timing information to be displayed at the display position of the target information in a superimposed manner on the image in accordance with a predetermined timing (Step S404). For example, the display control unit 171 causes the display unit 150 to display the timing information to be displayed at the display position of the target information in accordance with the predetermined timing corresponding to at least one of the beat, time, rhythm, or tempo of the music. For example, the display control unit 171 causes the display unit 150 to display the timing information moving in the image from the outside of the image toward a predetermined position according to at least one of the beat, time, rhythm, or tempo of the music. In addition, the display control unit 171 causes the display unit 150 to display the timing information in which the display mode (for example, color and the like) changes according to the song part of the music.

In addition, the detection unit 174 executes processing of penlight position detection/timing analysis (Step S405). The processing of penlight position detection/timing analysis is necessary for the information processing apparatus 100 to calculate a score corresponding to the position and timing of the penlight in the game app A1. Note that the processing of penlight position detection/timing analysis will be described in detail with reference to FIG. 8 described below, and thus the description thereof will be omitted here. Note that, hereinafter, the position of the penlight refers to the position of the light emitting portion of the penlight.

In addition, in a case where the relationship between the position of the penlight detected by the detection unit 174 and the display position of the target information satisfies a predetermined condition, the display control unit 171 causes the display unit 150 to display the effect information, which is information indicating a predetermined visual effect, in a superimposed manner on the image (Step S406). For example, in a case where the position of the penlight and the display position of the target information overlap at a predetermined timing as a predetermined condition, the display control unit 171 causes the display unit 150 to display the effect information. For example, in a case where the position of the penlight and the display position of the target information overlap at a predetermined timing, the display control unit 171 may cause the display unit 150 to display the effect information that is characters such as Perfect and Good.

Note that the information processing apparatus 100 executes the processing from Steps S403 to S406 described above in real time for each frame included in the moving image acquired from the camera.

In addition, the sound output control unit 175 determines whether or not the music has ended (Step S407). In a case where the sound output control unit 175 determines that the music has ended (Step S407; Yes), the information processing apparatus 100 ends the processing. The game of the game app A1 ends when the music ends. In addition, in a case where the sound output control unit 175 determines that the music is not ended (Step S407; No), the detection unit 174 acquires the moving image captured by the camera from the camera. Subsequently, the detection unit 174 extracts respective colors of the penlights and lighting regions corresponding to the respective colors of the penlights from each frame included in the acquired moving image (Step S403).

FIG. 8 is a flowchart illustrating a flow of processing of penlight position detection/timing analysis according to the embodiment. The processing of penlight position detection/timing analysis is started at the same time as the game of the game app A1 is started. The information processing apparatus 100 executes the processing of penlight position detection/timing analysis for each of all frames included in the moving image acquired from the camera or for each key frame included in the moving image acquired from the camera from the start to the end of the game of the game app A1. Note that the key frame may be, for example, a frame extracted at predetermined time intervals from all frames included in the moving image acquired from the camera.

In FIG. 8, the detection unit 174 detects a penlight from an image including a user carrying the penlight that emits light of a predetermined color (Step S501). Specifically, the detection unit 174 acquires the moving image captured by the camera from the camera. Subsequently, the detection unit 174 detects a penlight from each frame included in the acquired moving image. For example, the detection unit 174 determines whether or not a pixel having a luminance value exceeding a predetermined threshold is present among the pixels included in each frame. In addition, when determining that there is a pixel having a luminance value exceeding the predetermined threshold, the detection unit 174 determines that a penlight has been detected. Note that, since the information processing apparatus 100 has already executed the processing of initial setting including the processing of penlight color calibration and the processing of subject standing position/movable range calibration before the game is started, the penlight is detected with high probability at the stage of the game.

When the penlight is detected from the image by the detection unit 174, the display control unit 171 acquires information regarding the angle and position of the penlight in the image and the size of the penlight occupied in the image (Step S502). For example, the display control unit 171 specifies a region corresponding to the pixel having the luminance value exceeding the predetermined threshold in the image as a lighting region of the penlight (hereinafter, may be referred to as a penlight region). Subsequently, the display control unit 171 calculates the area of the penlight region occupied in the image. When calculating the area of the penlight region occupied in the image, the display control unit 171 determines whether or not the position of the penlight is located inside the region indicated by the target information (Step S503). For example, the display control unit 171 determines whether or not there is an overlapping region, which is a region where the position of the penlight and the display position of the target information overlap, in the image.

When determining that there is no overlapping region in the image, the display control unit 171 determines that the position of the penlight is not located inside the region indicated by the target information (Step S503; No). In a case where the display control unit 171 determines that the position of the penlight is not located inside the region indicated by the target information, the information processing apparatus 100 ends the processing.

In addition, when determining that there is an overlapping region in the image, the display control unit 171 determines that the position of the penlight is located inside the region indicated by the target information (Step S503; Yes). When determining that the position of the penlight is located inside the region indicated by the target information, the display control unit 171 determines whether the timing at which the position of the penlight is located inside the region indicated by the target information is correct (Step S504). Specifically, the display control unit 171 determines whether the penlight is located at the location indicated by the target information at the timing indicated by the timing information. For example, the display control unit 171 determines whether or not there is an overlapping region, which is a region where the position of the penlight and the display position of the target information overlap, at the timing indicated by the timing information.

When determining that there is no overlapping region in the image at the timing indicated by the timing information, the display control unit 171 determines that the penlight is not located at the location indicated by the target information at the timing indicated by the timing information. In addition, when determining that the penlight is not located at the location indicated by the target information at the timing indicated by the timing information, the display control unit 171 determines that the timing at which the position of the penlight is located inside the region indicated by the target information is incorrect (Step S504; No). In a case where the display control unit 171 determines that the timing is incorrect, the information processing apparatus 100 ends the processing.

In addition, when determining that there is an overlapping region in the image at the timing indicated by the timing information, the display control unit 171 determines that the penlight is located at the location indicated by the target information at the timing indicated by the timing information. In addition, when determining that the penlight is located at the location indicated by the target information at the timing indicated by the timing information, the display control unit 171 determines that the timing at which the position of the penlight is located inside the region indicated by the target information is correct (Step S504; Yes). When determining that the timing is correct, the display control unit 171 calculates the area of the overlapping region, which is a region where the position of the penlight and the display position of the target information overlap. Subsequently, the display control unit 171 calculates the ratio of the area of the overlapping region to the area occupied by the penlight in the image, and calculates a score based on the calculated ratio of the area (Step S505).

When the score is calculated, the display control unit 171 causes the display unit 150 to display the effect information corresponding to the score (Step S506). For example, the display control unit 171 causes the display unit 150 to display the effect information having a larger information amount as the score is higher. In addition, the display control unit 171 causes the display unit 150 to display the effect information with higher brightness, saturation, or luminance as the score is higher. Note that the sound output control unit 175 may cause the sound output unit 160 to temporarily output a voice such as cheer as the effect information. For example, the sound output control unit 175 may cause the sound output unit 160 to temporarily output a voice such as cheer with a larger volume as the score is higher.

### 2. Other Embodiments

The processing according to each embodiment described above may be performed in various different forms (modifications) other than each embodiment described above. Hereinafter, a modification and the like will be described.

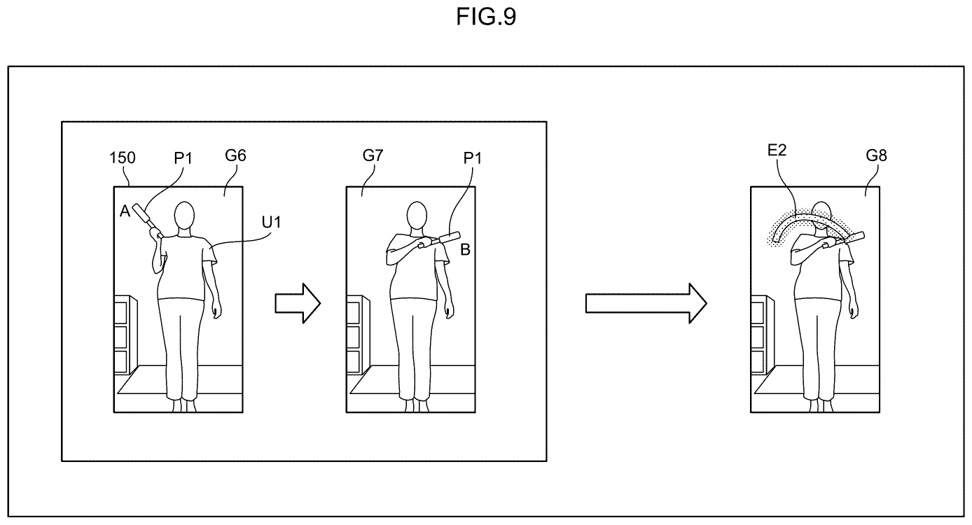

FIG. 9 is a diagram for describing an outline of display processing of effect information according to a modification. In FIG. 9, when the user waves the penlight left and right, the position of the penlight moves from the position of A illustrated in an image G6 to the position of B illustrated in an image G7 over several frames. At this time, on the basis of the position information of A in the image G6 and the position information of B in the image G7, the display control unit 171 causes the display unit 150 to display effect information E2 that visualizes the path of the penlight in a superimposed manner on an image G8 as illustrated on the right side in FIG. 9. In addition, the display control unit 171 causes the display unit 150 to display the effect information corresponding to the color of the penlight. For example, in a case where the color of the penlight illustrated in FIG. 9 is green, the display control unit 171 causes the display unit 150 to display the effect information E2 of green that is the same as the color of the penlight in a superimposed manner on the image G8.

Normally, when the penlight art is captured, capturing is performed by increasing the exposure time of the camera. In this case, since the subject is shaken when the subject moves, it is necessary to move only the penlight. On the other hand, the information processing apparatus 100 can add only effect information that visualizes the path of the penlight to the moving image without shaking the subject even if the subject moves.

In addition, in the above-described embodiment, the case where the target information has a heart shape has been described, but the target information may not have a heart shape. For example, the target information may be a symbol such as an arrow. In addition, the target information is not limited to a figure or a symbol, and may be a character. For example, the target information may be lyrics of music. For example, the target information may display a part of characters corresponding to the lyrics of the music in accordance with the music to be reproduced.

In addition, in the above-described embodiment, the case where the color of the target information is the same as the color of the penlight has been described, but the color of the target information may be the same as the image color (also referred to as the member color) of the member who sings its part according to the song part of the music. In this manner, the display control unit 171 may cause the display unit 150 to display the target information whose display mode changes according to the song part of the music.

In addition, in the above-described embodiment, the case where the display position of the target information is fixed to the upper left of the image has been described, but the display position of the target information may be a place other than the upper left of the image, or may not be fixed. For example, the display control unit 171 causes the display unit 150 to display the target information displayed at a predetermined position that changes according to the choreography of the music. In this case, the display control unit 171 causes the display unit 150 to display the timing information displayed at the display position of the target information that changes according to the choreography of the music. In addition, similarly to the timing information, the target information may move from the outside of the image, enter the image, move in the image, and then go back to the outside of the image. In addition, the display control unit 171 may detect a feature point of the user's face, and display the target information on the user's cheek in a superimposed manner, for example. In addition, the display control unit 171 may display the target information on a region other than the user's body region (for example, a region that does not cover the face) in a superimposed manner.

In addition, in the above-described embodiment, the case where the effect information El indicating the glittering stage effect is displayed in a superimposed manner on the image has been described, but the effect information is not limited to the glittering stage effect. For example, the effect information may be an image such as a bubble, a video, a character (for example, a character is displayed to cheer the user), or the like. In addition, when a predetermined condition is satisfied, the penlight itself may be changed. For example, in a case where the penlight is of the wireless control type, the information processing apparatus 100 may cause the penlight to flash sparkly or change the color to a rainbow color in a case where a predetermined condition is satisfied. In addition, the information processing apparatus 100 may cause the penlight to flash sparkly at a high speed according to at least one of the beat, time, rhythm, or tempo of the music. In addition, the information processing apparatus 100 may control the luminance of the penlight according to the score. For example, the information processing apparatus 100 may turn on the penlight more flashily as the score is higher.

In addition, among the pieces of processing described in each of the above embodiments, all or some of the pieces of processing described as being performed automatically can be performed manually, or all or some of the pieces of processing described as being performed manually can be performed automatically by a known method. In addition, the processing procedures, the specific names, and the information including various data and parameters indicated in the above document and the drawings can be arbitrarily changed unless otherwise specified. For example, the various types of information illustrated in each drawing are not limited to the illustrated information.

In addition, each component of each apparatus illustrated in the drawings is functionally conceptual, and is not necessarily physically configured as illustrated in the drawings. That is, a specific form of distribution and integration of apparatuses is not limited to those illustrated, and all or a part thereof can be functionally or physically distributed and integrated in an arbitrary unit according to various loads, usage situations, and the like.

In addition, the above-described embodiments and modification can be appropriately combined within a range not contradicting processing contents.

### 3. Effects

As described above, the information processing apparatus 100 according to each embodiment of the present disclosure includes the detection unit 174 and the display control unit 171. The detection unit 174 detects a light emitter from an image including a user carrying the light emitter that emits light of a predetermined color. The display control unit 171 causes the display unit 150 to display first display information displayed at a predetermined position in the image in a superimposed manner on the image. In addition, in a case where the relationship between the position of the light emitter detected by the detection unit 174 and the predetermined position satisfies a predetermined condition, the display control unit 171 causes the display unit 150 to display the effect information, which is information indicating a predetermined visual effect, in a superimposed manner on the image.

As a result, the information processing apparatus 100 can enable the user to perform a movement performed using the light emitter (for example, movement of choreography according to the music) anytime and anywhere (for example, even at home). That is, the information processing apparatus 100 can provide an opportunity for the user to enjoy using the light emitter at a place other than the event venue (for example, home). In addition, the information processing apparatus 100 can support the user to improve the movement (for example, the movement of choreography according to music) performed by using the light emitter.

In addition, the display control unit 171 causes the display unit 150 to display the second display information displayed at a predetermined position in accordance with a predetermined timing in a superimposed manner on the image, and causes the display unit 150 to display the effect information when the position of the light emitter overlaps with the predetermined position at the predetermined timing as a predetermined condition.

As a result, the information processing apparatus 100 can guide the user so that the position of the light emitter is aligned with the display position of the first display information at the predetermined timing. Accordingly, the information processing apparatus 100 can support the user to improve the movement (for example, the movement of choreography according to music) performed by using the light emitter.

In addition, the display control unit 171 calculates the area of the overlapping region, which is a region where the position of the light emitter and the predetermined position overlap, calculates a score based on the ratio of the area of the overlapping region to the area occupied by the light emitter in the image, and causes the display unit 150 to display the effect information corresponding to the score.

As a result, the information processing apparatus 100 can guide the user so that the region indicated by the first display information includes the region of the light emitter more. Accordingly, the information processing apparatus 100 can support the user to improve the movement (for example, the movement of choreography according to music) performed by using the light emitter.

In addition, the display control unit 171 causes the display unit 150 to display the effect information corresponding to the predetermined color.

As a result, the information processing apparatus 100 can realistically express the effect information that visualizes the path of the light emitter, for example.

In addition, the information processing apparatus 100 further includes the sound output control unit 175. The sound output control unit 175 causes the sound output unit 160 to output a voice of the music. The display control unit 171 causes the display unit 150 to display the second display information to be displayed at the predetermined position in accordance with the predetermined timing corresponding to at least one of the beat, time, rhythm, or tempo of the music.

As a result, the information processing apparatus 100 can guide the user so that the position of the light emitter is aligned with the display position of the first display information at the predetermined timing according to at least one of the beat, time, rhythm, or tempo of the music. Accordingly, the information processing apparatus 100 can support the user to improve the movement (for example, the movement of choreography according to music) performed by using the light emitter.

In addition, the sound output control unit 175 causes the sound output unit 160 to output a voice of the music. The display control unit 171 causes the display unit 150 to display the first display information displayed at a predetermined position that changes according to the choreography of the music.

As a result, the information processing apparatus 100 can support the user to improve the movement of the choreography of the music.

In addition, the sound output control unit 175 causes the sound output unit 160 to output a voice of the music. The display control unit 171 causes the display unit 150 to display the second display information displayed at a predetermined position that changes according to the choreography of the music.

As a result, the information processing apparatus 100 can support the user to improve the movement of the choreography of the music.

In addition, the sound output control unit 175 causes the sound output unit 160 to output a voice of the music. The display control unit 171 causes the display unit 150 to display the second display information whose display mode changes according to the song part of the music.

As a result, the information processing apparatus 100 can enable the user to enjoy the movement (for example, the movement of choreography according to music) performed by using the light emitter.

In addition, the sound output control unit 175 causes the sound output unit 160 to output a voice of the music. The display control unit 171 causes the display unit 150 to display the first display information whose size changes according to the beat of the music.

As a result, the information processing apparatus 100 can enable the user to enjoy a movement performed using the light emitter (for example, movement of choreography according to the music) to the beat of the music.

In addition, the sound output control unit 175 causes the sound output unit 160 to output a voice of the music. The display control unit 171 causes the display unit 150 to display the second display information moving in the image from the outside of the image toward a predetermined position according to at least one of the beat, time, rhythm, or tempo of the music.

As a result, the information processing apparatus 100 can guide the user so that the position of the light emitter is aligned with the display position of the first display information at the predetermined timing according to at least one of the beat, time, rhythm, or tempo of the music by the user.

In addition, the shape of the second display information is the same as or similar to the shape of the first display information.

As a result, the information processing apparatus 100 can cause the user to expect that the timing information is superimposed on the position of the target information.

### 4. Hardware Configuration

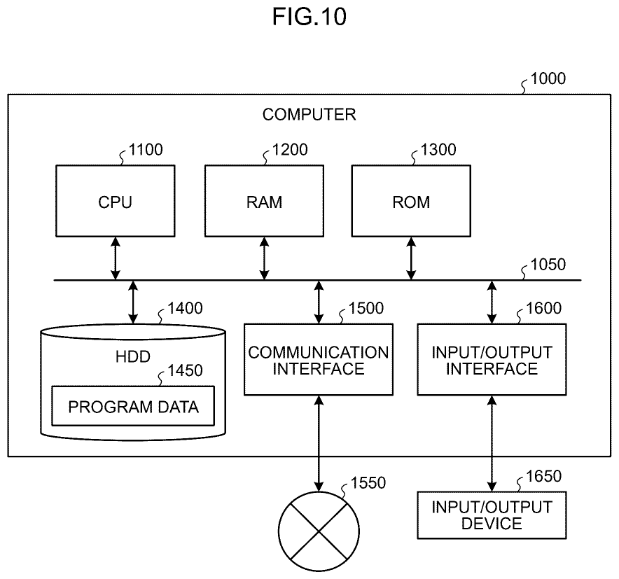

An information device such as the information processing apparatus 100 according to the above-described embodiment is reproduced by a computer 1000 having the configuration as illustrated, for example, in FIG. 10. FIG. 10 is a hardware configuration diagram illustrating an example of a computer that achieves a function of the information processing apparatus according to the present disclosure. Hereinafter, the information processing apparatus 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 loads the program stored in the ROM 1300 or the HDD 1400 to the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable non-transitory recording medium that non-transiently records a program executed by the CPU 1100, data used by the program, and the like. Specifically, the HDD 1400 is a non-transitory recording medium that records a program according to the present disclosure, which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from the input device such as a keyboard and a mouse via the input/output interface 1600. In addition, the CPU 1100 transmits data to the output device such as a display, a speaker, a printer, or the like via the input/output interface 1600. In addition, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 executes a program loaded on the RAM 1200 to reproduce the function of the control unit 170 and the like. In addition, the HDD 1400 stores a program according to the present disclosure and various data. Note that the CPU 1100 reads the program data 1450 from the HDD 1400 and executes the program data, but as another example, these programs may be acquired from another apparatus via the external network 1550.

In addition, the effects described in the present specification are merely illustrative or exemplary and are not limiting. That is, the technique according to the present disclosure can have other effects apparent to those skilled in the art from the description of the present specification, in addition to or instead of the above effects.

Note that the present technique can also have the following configurations.
(1)

An information processing apparatus comprising:
a detection unit that detects a light emitter that emits light of a predetermined color from an image including a user carrying the light emitter; and
a display control unit that causes a display unit to display first display information displayed at a predetermined position in the image in a superimposed manner on the image, wherein
the display control unit,
in a case where a relationship between a position of the light emitter detected by the detection unit and the predetermined position satisfies a predetermined condition, causes the display unit to display effect information that is information indicating a predetermined visual effect in a superimposed manner on the image.
(2)

The information processing apparatus according to (1), wherein
the display control unit
causes the display unit to display second display information displayed at the predetermined position in accordance with a predetermined timing in a superimposed manner on the image, and causes the display unit to display the effect information when the position of the light emitter overlaps with the predetermined position at the predetermined timing as a predetermined condition.
(3)

The information processing apparatus according to (2), wherein
the display control unit
calculates an area of an overlapping region that is a region where the position of the light emitter and the predetermined position overlap, calculates a score based on a ratio of the area of the overlapping region to an area occupied by the light emitter in the image, and causes the display unit to display the effect information corresponding to the score.
(4)

The information processing apparatus according to any one of (1) to (3), wherein
the display control unit
causes the display unit to display the effect information corresponding to the predetermined color.
(5)

The information processing apparatus according to any one of (2) to (4), further comprising:
a sound output control unit that causes a sound output unit to output a voice of music, wherein
the display control unit
causes the display unit to display the second display information displayed at the predetermined position in accordance with the predetermined timing corresponding to at least one of beat, time, rhythm, or tempo of the music.
(6)

The information processing apparatus according to any one of (1) to (5), further comprising:
a sound output control unit that causes a sound output unit to output a voice of music, wherein
the display control unit
causes the display unit to display the first display information displayed at the predetermined position that changes according to choreography of the music.
(7)

The information processing apparatus according to any one of (2) to (6), further comprising:
a sound output control unit that causes a sound output unit to output a voice of music, wherein
the display control unit
causes the display unit to display the second display information displayed at the predetermined position that changes according to choreography of the music.
(8)

The information processing apparatus according to any one of (2) to (7), further comprising:
a sound output control unit that causes a sound output unit to output a voice of music, wherein
the display control unit
causes the display unit to display the second display information whose display mode changes according to a song part of the music.
(9)

The information processing apparatus according to any one of (1) to (8), further comprising:
a sound output control unit that causes a sound output unit to output a voice of music, wherein
the display control unit
causes the display unit to display the first display information whose size changes according to a beat of the music.
(10)

The information processing apparatus according to any one of (2) to (9), further comprising:
a sound output control unit that causes a sound output unit to output a voice of music, wherein
the display control unit
causes the display unit to display the second display information moving in the image from outside of the image toward the predetermined position according to at least one of beat, time, rhythm, or tempo of the music.
(11)

The information processing apparatus according to any one of (2) to (10), wherein
a shape of the second display information is same as or similar to a shape of the first display information.
(12)

An information processing method comprising:
detecting a light emitter that emits light of a predetermined color from an image including a user carrying the light emitter;
causing a display unit to display first display information displayed at a predetermined position in the image in a superimposed manner on the image; and,
in a case where a relationship between a position of the detected light emitter and the predetermined position satisfies a predetermined condition, causing the display unit to display effect information that is information indicating a predetermined visual effect in a superimposed manner on the image.
(13)

A computer-readable non-transitory storage medium storing a program for causing a computer to implement:
detecting a light emitter that emits light of a predetermined color from an image including a user carrying the light emitter;
causing a display unit to display first display information displayed at a predetermined position in the image in a superimposed manner on the image; and,
in a case where a relationship between a position of the detected light emitter and the predetermined position satisfies a predetermined condition, causing the display unit to display effect information that is information indicating a predetermined visual effect in a superimposed manner on the image.

### REFERENCE SIGNS LIST

100 INFORMATION PROCESSING APPARATUS
110 COMMUNICATION UNIT
120 STORAGE UNIT
130 INPUT UNIT
140 SENSOR UNIT
141 IMAGING UNIT
150 DISPLAY UNIT
160 SOUND OUTPUT UNIT
170 CONTROL UNIT
171 DISPLAY CONTROL UNIT
172 RECEPTION UNIT
173 CAMERA CONTROL UNIT
174 DETECTION UNIT
175 SOUND OUTPUT CONTROL UNIT

1. An information processing apparatus comprising:
a detection unit that detects a light emitter that emits light of a predetermined color from an image including a user carrying the light emitter; and
a display control unit that causes a display unit to display first display information displayed at a predetermined position in the image in a superimposed manner on the image, wherein
the display control unit,
in a case where a relationship between a position of the light emitter detected by the detection unit and the predetermined position satisfies a predetermined condition, causes the display unit to display effect information that is information indicating a predetermined visual effect in a superimposed manner on the image.

2. The information processing apparatus according to claim 1, wherein
the display control unit
causes the display unit to display second display information displayed at the predetermined position in accordance with a predetermined timing in a superimposed manner on the image, and causes the display unit to display the effect information when the position of the light emitter overlaps with the predetermined position at the predetermined timing as a predetermined condition.

3. The information processing apparatus according to claim 2, wherein
the display control unit
calculates an area of an overlapping region that is a region where the position of the light emitter and the predetermined position overlap, calculates a score based on a ratio of the area of the overlapping region to an area occupied by the light emitter in the image, and causes the display unit to display the effect information corresponding to the score.

4. The information processing apparatus according to claim 1, wherein
the display control unit
causes the display unit to display the effect information corresponding to the predetermined color.

5. The information processing apparatus according to claim 2, further comprising:
a sound output control unit that causes a sound output unit to output a voice of music, wherein
the display control unit
causes the display unit to display the second display information displayed at the predetermined position in accordance with the predetermined timing corresponding to at least one of beat, time, rhythm, or tempo of the music.

6. The information processing apparatus according to claim 1, further comprising:
a sound output control unit that causes a sound output unit to output a voice of music, wherein
the display control unit
causes the display unit to display the first display information displayed at the predetermined position that changes according to choreography of the music.

7. The information processing apparatus according to claim 2, further comprising:
a sound output control unit that causes a sound output unit to output a voice of music, wherein
the display control unit
causes the display unit to display the second display information displayed at the predetermined position that changes according to choreography of the music.

8. The information processing apparatus according to claim 2, further comprising:
a sound output control unit that causes a sound output unit to output a voice of music, wherein
the display control unit
causes the display unit to display the second display information whose display mode changes according to a song part of the music.

9. The information processing apparatus according to claim 1, further comprising:
a sound output control unit that causes a sound output unit to output a voice of music, wherein
the display control unit
causes the display unit to display the first display information whose size changes according to a beat of the music.

10. The information processing apparatus according to claim 2, further comprising:
a sound output control unit that causes a sound output unit to output a voice of music, wherein
the display control unit
causes the display unit to display the second display information moving in the image from outside of the image toward the predetermined position according to at least one of beat, time, rhythm, or tempo of the music.

11. The information processing apparatus according to claim 2, wherein
a shape of the second display information is same as or similar to a shape of the first display information.

12. An information processing method comprising:
detecting a light emitter that emits light of a predetermined color from an image including a user carrying the light emitter;
causing a display unit to display first display information displayed at a predetermined position in the image in a superimposed manner on the image; and,
in a case where a relationship between a position of the detected light emitter and the predetermined position satisfies a predetermined condition, causing the display unit to display effect information that is information indicating a predetermined visual effect in a superimposed manner on the image.

13. A computer-readable non-transitory storage medium storing a program for causing a computer to implement:
detecting a light emitter that emits light of a predetermined color from an image including a user carrying the light emitter;
causing a display unit to display first display information displayed at a predetermined position in the image in a superimposed manner on the image; and,
in a case where a relationship between a position of the detected light emitter and the predetermined position satisfies a predetermined condition, causing the display unit to display effect information that is information indicating a predetermined visual effect in a superimposed manner on the image.
